(19) United States
(12) Patent Application Publication
(10) Pub. No.: US 2020/0249160 A1
(43) Pub. Date: Aug. 6, 2020

(54) NANOSCALE OPTICAL VOLTAGE SENSORS

(71) Applicants: Anxiang YIN, Los Angeles, CA (US); THE REGENTS OF THE UNIVERSITY OF CALIFORNIA, Oakland, CA (US)

(72) Inventors: Xiangfeng DUAN, Los Angeles, CA (US); Anxiang YIN, Los Angeles, CA (US)

(21) Appl. No.: 15/776,059

(22) PCT Filed: Nov. 17, 2016
(86) PCT No.: PCT/US2016/062561

§ 371 Date: May 14, 2018

Related U.S. Application Data
(60) Provisional application No. 62/256,648, filed on Nov. 17, 2015.

(51) Int. Cl. G01N 21/552; G01N 21/27; B82Y 15/00; G01N 21/64

(52) U.S. Cl. CPC G01N 21/554; G01N 21/27; G01N 23/06; G01N 21/648; B82Y 15/00

(57) ABSTRACT

A sensor includes a nanostructure, which includes a domain of a first material and a domain of a second material that covers the domain of the first material. The first material is a plasmonic material, and the second material is a non-linear optical material.

### CROSS-REFERENCE TO RELATED APPLICATION

This application claims the benefit of U.S. Provisional Application No. 62/256,648, filed Nov. 17, 2015, the content of which is incorporated herein by reference in its entirety.

### BACKGROUND

The design of optical reporters of a voltage signal (optical voltage sensors) is of considerable interest for diverse applications, such as for recording cell membrane potential and neural activities. Such optical reporters may omit electrical wiring and can allow for highly parallel interrogation of a large number of cells in neural circuits. However, despite the benefits, many optical voltage sensors, such as organic dyes or genetically coded fluorescence proteins, rely on indirect measurement of voltage signal and are constrained by relatively slow temporal response, high activation threshold or low photo-stability. Therefore, the continued development of optical voltage sensors that can sensitively and rapidly transduce electrical signal is desired for highly parallel monitoring the dynamic activities in neural circuits with high spatiotemporal resolution.

It is against this background that a need arose to develop the embodiments described in this disclosure.

### SUMMARY

One aspect of this disclosure relates to a sensor. In some embodiments, the sensor includes a nanostructure, which includes a domain of a first material and a domain of a second material that covers the domain of the first material. The first material is a plasmonic material, and the second material is a non-linear optical material.

In some embodiments, the domain of the first material is a core, and the domain of the second material is a shell covering the core.

In some embodiments, the first material includes a noble metal.

In some embodiments, the domain of the first material includes two different noble metals.

In some embodiments, the second material includes a conductive organic polymer.

In some embodiments, the second material is inorganic.

In some embodiments, the second material includes graphene.

In some embodiments, the nanostructure further includes a coating of a biocompatible material, and the coating covers the domain of the second material.

In some embodiments, the nanostructure is surface functionalized by organic ligands.

In some embodiments, the nanostructure further includes a phosphor.

In some embodiments, the phosphor covers the domain of the second material, or is embedded in at least one of the domain of the first material or the domain of the second material.

Another aspect of this disclosure relates to a method of sensing. In some embodiments, the method includes: 1) providing a nanostructure including a domain of a first material and a domain of a second material that covers the domain of the first material, where the first material is a plasmonic material, and the second material is a non-linear optical material; 2) placing the nanostructure at a target location; 3) applying an input optical signal to the nanostructure at the target location; and 4) measuring an output optical signal induced by the nanostructure in response to an electric field at the target location.

In some embodiments, the input optical signal is polarized light having a polarization direction, the nanostructure is elongated along a longitudinal axis, and applying the input optical signal includes aligning the polarization direction so as to be substantially parallel to the longitudinal axis.

In some embodiments, the output optical signal has a peak in a visible range or an infrared range.

In some embodiments, the output optical signal is a plasmonic scattering signal.

In some embodiments, measuring the output optical signal includes measuring a shift in a peak of the plasmonic scattering signal.

In some embodiments, the nanostructure further includes a phosphor, and measuring the output optical signal includes measuring a fluorescence signal.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1. Design of Au/PANI nanorods (NRs) as a single-particle plasmonic resonance modulator and nanoscale optical voltage sensor (NOVS). a) The design and synthesis of Au/PANI NRs. b) Schematic illustration of field-dependent single particle spectroscopy. c) Voltage-modulated local surface plasmonic resonance (LSPR) scattering, illustrating a local electric field induced shift of the scattering peak.

FIG. 2. Transmission electron microscope (TEM) images for Au/PANI NRs with different shell thickness. a, b) TEM images for Au/PANI NRs with a shell thickness of about 5 to about 10 nm. c, d) TEM images for Au//PANI NRs with a shell thickness of about 20 nm. The scale bar is 200 nm in panel a, c, and 20 nm in b, d.

FIG. 3. Single particle scattering image and spectroscopy for Au/PANI NRs. a) Dark field image of individual Au/PANI NRs on glass substrates. The scale bar is 10 μm. b) Single particle scattering spectra for Au/PANI NRs with different aspect ratios. c) False color scattering images for a single Au/PANI NR under incident light of variable polarization directions. d) The polarization dependence of the scattering intensity for the Au/PANI NR shown in panel c.

FIG. 4. Dynamic modulation of LSPR scattering spectra of a single Au/PANI NR by an external electric field. a) Dark field image for Au/PANI NRs between a pair of electrodes on glass substrates. The scale bar is 5 b) The LSPR spectra with (right) and without (left) a parallel electrical field. c) No noticeable modulation of LSPR spectra is observed when the electrical field direction is substantially perpendicular to the NR axis. The electric field (about 10 V/μm) is set to “off” or “on”. The arrows labeled with “P” and “E” shown in the insets represent the directions of the polarization of the incident light and the external electric field, respectively. d) Spectral shifts of the LSPR peak for a single Au/PANI NR under different electrical fields (10 measurements for each point). e) A series of 100 successive spectra obtained from a single Au/PANI NR under a periodically modulating field. The field modulation frequency is about 1 Hz and the single frame integration for each spectra is about 200 ms (5 frames of spectra for each on/off window). f) The switch of LSPR peak position with on/off electrical field (about 10 V/μm).

FIG. 5. Simulation of LSPR spectral shift for a single Au/PANI NR with different refractive index (nₛ) of a surrounding medium and different shell thickness. a) Simulated LSPR spectra for a NR (aspect ratio of about 1.6) with a shell (about 20 nm) of different refractive index. b) LSPR spectral peak vs. shell refractive index for NRs with different shell thickness (about 5, 10, and 20 nm). The substrate is glass (silica) and the upper atmosphere is air for all simulations.

FIG. 6. TEM images for Au NRs with different aspect ratios (a-d) and their corresponding extinction spectra (e). The scale bar in panel a-d is 100 nm. Au NRs with different aspect ratios can be prepared through the seeded growth method. Their corresponding LSPR extinction spectra show a significant blue-shift with a decrease in the aspect ratios.

FIG. 7. Scheme illustration for a dark-field optical microscope (50× Olympus dark-field objective, NA=about 0.50) with an integrated monochromator (Acton SpectraPro 2300i), and a liquid-nitrogen-cooled charge-coupled device (CCD) camera (Princeton Instruments Spec10). A dark-field optical microscope with both a color CCD and a spectrometer was used to capture a dark-field image and corresponding scattering spectra for a single LSPR nanoparticle. The selection of a certain single particle is realized by applying a narrow, tunable slit before the monochromator and choosing specific pixels in the CCD.

FIG. 8. Dark-field images of Au/PANI NR between two counter electrodes (indicated by arrows) recorded by a color CCD (a) and a spectra CCD (b), and the corresponding scattering spectra (c). In panel b, a slit is applied to avoid the influence from the scattering light of the electrodes and other nanostructures. The scale bar in panel a and b is 5 and 2 μm, respectively. A single Au/PANI NR between two counter electrodes can be observed through the color CCD and then can be isolated from other nanostructures as well as the electrodes by applying a narrow slit. The scattering spectra for this specific NR can be then collected with a rotating grating and the spectra CCD.

FIG. 9. LSPR scattering spectra for a single bare Au NR under an external electric field (about 10 V/μm), which is set to the “off” or “on” state. For each state of the electric field, 2 spectra were collected. The arrow in the inset indicates the direction of the long axis of the NR, as well as the direction of the electric field and the polarization of the incident light. No noticeable shift in the LSPR frequency can be observed.

FIG. 10. The effect of directions of the polarization of an incident light and an applied electric field upon the response of scattering spectra for a single Au/PANI NR to the external electric field. The dark curves represent “off” state and other curves represent “on” state. (a) The longitudinal axis of the NR is substantially parallel to the electric field but substantially vertical to the polarization direction, (b) the longitudinal axis of the NR is substantially vertical to both the polarization direction and the electric field. The strength of the applied electric field is about 10 V/μm. The arrows labeled with “P” and “E” represent the directions of the polarization of the incident light and the external electric field, respectively.

FIG. 11. LSPR scattering spectra for a single Au/PANI NR with a shell of about 20 nm under an external electric field (about 10 V/μm), which is set to the “off” or “on” state. For each state of the electric field, 4 spectra were collected. The arrow in the inset indicates the direction of the long axis of the NR, as well as the direction of the electric field and the polarization of the incident light. By switching the external electric field “on”, a significant red-shift can be observed in the LSPR spectra. And the LSPR spectra would recover when the electric field is turned “off”. These repeated tests show that the switching behavior for the Au/PANI NRs is reversible and robust.

FIG. 12. LSPR scattering spectra for a single Au/PANI NR with a shell of about 5 nm under an external electric field (about 10 V/μm), which is set to the “off” or “on” state. The arrow in the inset indicates the direction of the long axis of the NR, as well as the direction of the electric field and the polarization of the incident light. No noticeable shift in the LSPR frequency can be observed.

FIG. 13. Electric field modulation of Au/BTO NRs. a. TEM images of Au/BTO NRs. b. Enlarged TEM image for a single Au/BTO NR. c. Single particle scattering spectra for a single Au/BTO NR without (left) and with (right) a local electric field of about 20 V/μm. The scale bar is 200 and 50 nm in panel a and b, respectively.

FIG. 14. Simulation of LSPR spectral shift for a single Au/PANI NR with different refractive index (nₛ) of the surrounding medium and different shell thickness, showing the simulated field distribution around the Au/PANI core/shell nanostructure.

FIG. 15. Plasmonic nanostructures with tunable compositions, shapes, sizes, and LSPR spectra. TEM images for (a-c) Au NRs with different aspect ratios, (d-f) Au/Ag NRs with different aspect ratios, and (g-i) Au/Ag nanocubes with different shell thickness. (j) The corresponding extinction spectra of these nanostructures show highly tunable LSPR spectra. For the Au NRs, the extinction spectra are dominated by a tunable longitudinal LSPR mode in red-infrared regime with a less tunable transverse LSPR mode of about 510 nm.

FIG. 16. Plasmonic/NLO core/shell nanostructures. (a) Schematic illustration for coating Au NRs with shells of different NLO materials and different thicknesses. TEM images of (b-c) Au/PANI NRs with different shell thicknesses, (d) Au/BTO NRs, and (e) Au/Graphene nanoparticle. The scale bar is 200 nm in panel (b-d), and 10 nm in panel (e).

FIG. 17. Schematic illustration of different surface modifications of a NOVS for delivery to a cell membrane. (a) Selective coating of hydrophilic/hydrophobic layers onto the NOVS with controlled location. (b) NOVS with different surface coatings embedded in or positioned across a lipid bilayer.

FIG. 18. Schematic illustration of an integration of fluorescent phosphors with plasmonic/NLO nanostructures to convert a plasmonic scattering signal to a fluorescence signal. (a) Different designs of NOVS with various phosphors: including Au/PANI/Dye and Au/PANI/ up-conversion nanoparticles (UCNPs) core/shell/shell, and Au/PANI nanostructures in which UCNPs are embedded. (b) Coupling between LSPR of cores and FL signals of phosphors. (c) A change of an external field modulates an overlap of the fluorescence and the scattering spectra, and thus fluorescence intensity. (d) Typical up-conversion spectra for UCNPs with multiple emission bands. The overlap between up-conversion FL spectra and the LSPR spectra for Ag or Au nanostructures are highlighted on the left and right, respectively.

### DESCRIPTION

### Plasmonic/Non-linear Optical Material Core/shell Nanorods as Nanoscale Plasmon Modulators and Optical Voltage Sensors

Some embodiments are directed to the design and synthesis of plasmonic/non-linear optical (NLO) material core/shell nanostructures that can allow dynamic manipulation of light signals using an external electrical field and provide nanoscale optical voltage sensors. It is shown that gold nanorods (Au NRs) can be synthesized with tunable plasmonic properties and function as nucleation seeds for continued growth of a shell of NLO materials (e.g., polyaniline or PANI) with variable thickness. The formation of PANI nanoshell can allow dynamic modulation of a dielectric environment of the plasmonic Au NRs and therefore the plasmonic resonance characteristics by an external electrical field. Single particle scattering spectroscopic studies of Au/PANI core/shell NRs reveal that their plasmonic resonance frequency can be rapidly modulated with an external electric field. The finite element simulation confirms that such modulation is originated from the field-induced modulation of the dielectric constant of the NLO shell. This approach is general, and coating of the Au NRs with other NLO materials (e.g., barium titanate or BTO) is found to produce a similar effect. These findings can open a pathway to active modulation of plasmonic resonance at a sub-wavelength scale and also can provide the creation of nanoscale optical voltage sensors (NOVS). The approach can broadly impact areas including nanoscale electro-optics and in vitro or in vivo voltage sensors for highly parallel monitoring of cellular membrane potential in real-time.

The local surface plasmonic resonance (LSPR) property of noble metal (e.g., Au, Ag, and so forth) and other metal (e.g., Al) nanostructures can allow for light manipulation at the sub-wavelength scale, and provide exciting technological opportunities in diverse fields, including sensing, photovoltaics, catalysis, and optical antennas. The plasmonic resonance properties of noble metal nanostructures can be controlled by the composition, size, morphology and the surrounding dielectric environment. The composition, size, and morphology of a given plasmonic nanostructure are typically fixed and cannot be varied in a dynamic way after its initial synthesis or fabrication. Thus, the manipulation of the surrounding dielectric environment is desirable for active modulation of the plasmonic resonance for diverse applications. Considerable efforts have been devoted to investigating the interaction between plasmonic nanostructures and the surrounding environments, such as electro- and photo-chromic molecules, inorganic materials, polymers, and liquid crystals. On one hand, the plasmonic resonance can substantially modify the optical properties of the nearby materials, for example, to enhance the absorption or accelerate the radiative decay rate. On the other hand, the variation of the surrounding dielectric environment may significantly alter the plasmonic resonance properties of metallic nanostructures. Therefore, the integration of plasmonic nanostructures with active dielectric materials can provide active modulation of the plasmonic resonance by using an external stimulus or trigger (e.g., light, heat, or electric potential) and may open a pathway to advanced nano-devices, including active metamaterials, smart windows, and displays, as well as nanoscale sensors that can sensitively monitor local environmental changes.

Some embodiments explore the interaction between plasmonic nanostructures and NLO materials to provide active modulation of the dielectric environment and thus plasmonic properties by an external electrical field. Au nanorods (NRs) with specific aspect ratio are used as a model system due to their high stability, strong and tunable plasmonic resonance in the visible region, and high sensitivity to the change of surrounding dielectric environment. Both organic polyaniline (PANI) and inorganic barium titanium oxide (BTO) are evaluated as two examples of NLO materials. PANI represents a semiconducting polymer with tunable conductivity, dielectric function and thus excellent NLO properties. BTO is a perovskite-type inorganic material with unusual ferroelectric and electro-optic properties, which are more applicable for ultrafast optical switches but usually with smaller piezoelectric coefficients as compared to organic NLO materials. The Au NRs and NLO materials are integrated together to form Au/NLO core/shell NRs (FIG. 1a) and the modulation of the plasmonic properties by an external electrical field is studied by using a single particle scattering spectroscopy approach (FIG. 1b). The Au/PANI NRs exhibit a significant, robust and reversible plasmon peak shift when triggered by an external electric field. The electrical switching behavior for these plasmonic NRs shows a strong dependence on the NR orientation, the electric field direction, and the polarization direction of the incident light. In addition, this concept can be extended to Au/BTO core/shell NRs, which show similar electro-optical modulation.

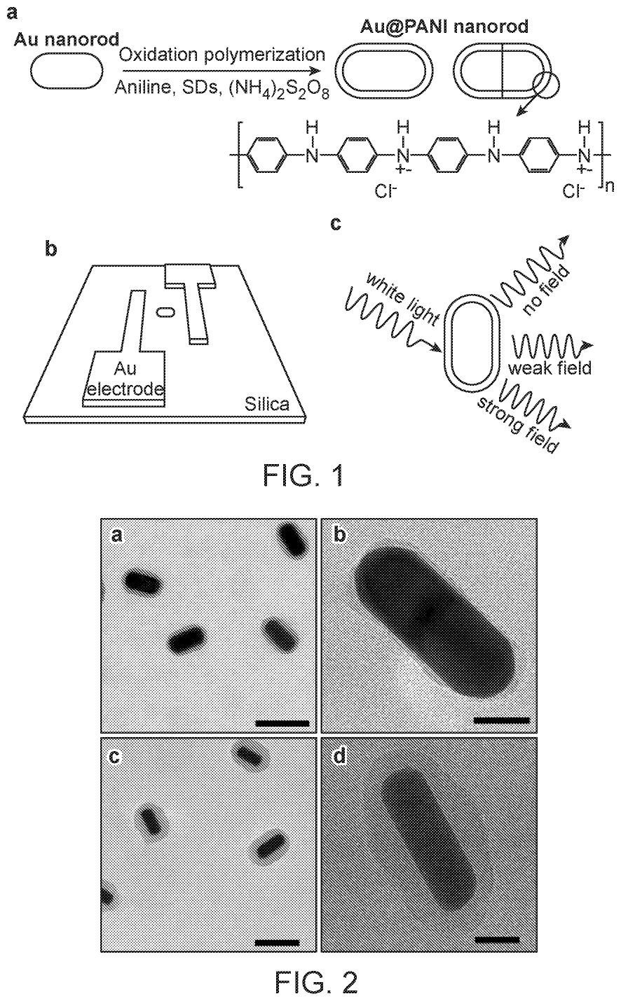

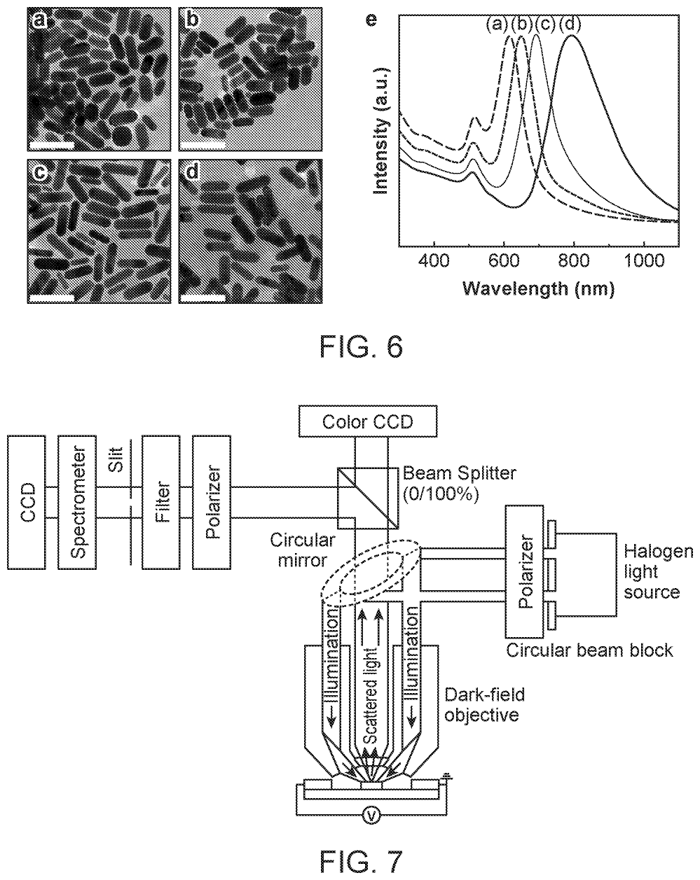

Au NRs with controlled aspect ratios and tunable LSPR scattering frequencies were prepared using a seeded method with cetyltrimethylammonium bromide (CTAB) as the stabilizing and structure directing agent. Au NRs with a proper aspect ratio are used as a model system to ensure the scattering spectra were located in the visible range for the convenience of the study (FIG. 6). A similar strategy can be applied to other plasmonic nanostructures with different plasmon resonance frequencies. A substantially uniform PANI shell was coated onto the Au NRs with controllable thickness using a modified oxidative polymerization method. In brief, a mixture solution of sodium dodecylsulfate (SDS) and aniline was added into the CTAB-capped Au NR solution. A strong oxidant, (NH₄)₂S₂O₈, was then introduced into the mixture and the polymerization of aniline occurred on the surface of the Au NRs, producing a PANI shell on the surface of Au NRs. The resulting Au/PANI NRs were separated from the solution through a centrifugation process. The thickness of the PANI coating can be controlled in the range of about 5-20 nm by tuning the molar ratio of aniline monomers or by repeating the coating process for multiple times (FIG. 2a-d).

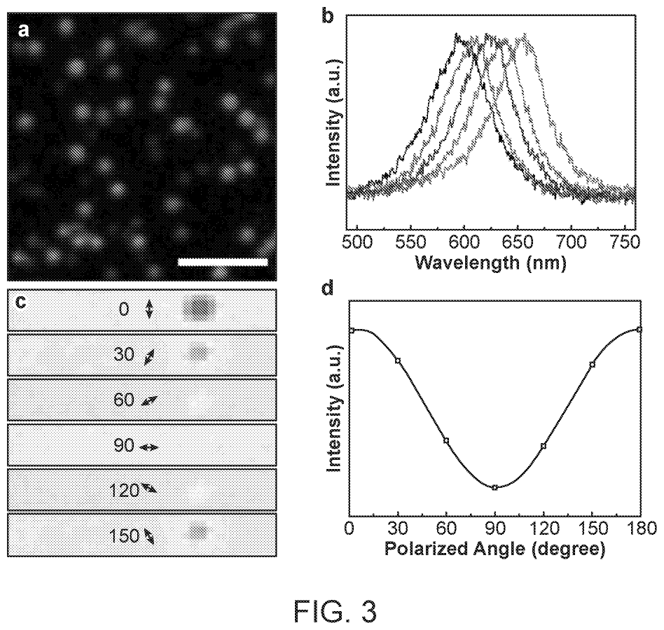

To inspect the plasmonic properties of individual nanostructures, the Au/PANI NRs were deposited onto silicon/silicon oxide or glass substrates using a dip-coating method. The scattering images or spectra for individual Au/PANI core/shell NRs were collected using a dark-field optical microscope (with a 50× Olympus dark-field objective, NA=about 0.50) with an integrated monochromator (Acton SpectraPro 2300i), and a liquid-nitrogen-cooled charge-coupled device (CCD) camera (Princeton Instruments Spec10) (FIG. 7). The individual NRs can be readily identified under the dark-field optical microscope (FIG. 3a) and the corresponding scattering spectra for a single Au/PANI NR can be collected by the integrated spectrometer (FIG. 3b). The single-particle spectroscopy of the Au/PANI NR reveals a plasmonic resonance peak between about 590 and about 660 nm, corresponding to the longitudinal plasmon resonance mode of the NRs, which may be readily tuned by varying the aspect ratios of the Au NRs (FIG. 6). For convenience and spectral matching with sensitivity of the CCD cameras, NRs with LSPR peaks of about 620 nm are focused to probe the electrical field modulated plasmonic properties. It is noted that the longitudinal LSPR scattering spectra for a single Au/PANI NR can be strongly dependent on the polarization direction of the incident light (FIG. 3c,d). The scattering intensity can reach its maximum value when the polarization direction is substantially parallel to longitudinal NR axis, and when the polarization direction is perpendicular to the longitudinal NR axis, no noticeable scattering image or spectral peak can be observed since the transverse LSPR is too weak. In this way, the long axis of a specific NR can be determined by rotating a polarizer between the incident light and the specimen. The orientation of the NR longitudinal axis corresponds to the polarization direction at which the LSPR scattering intensity reaches the maximum value.

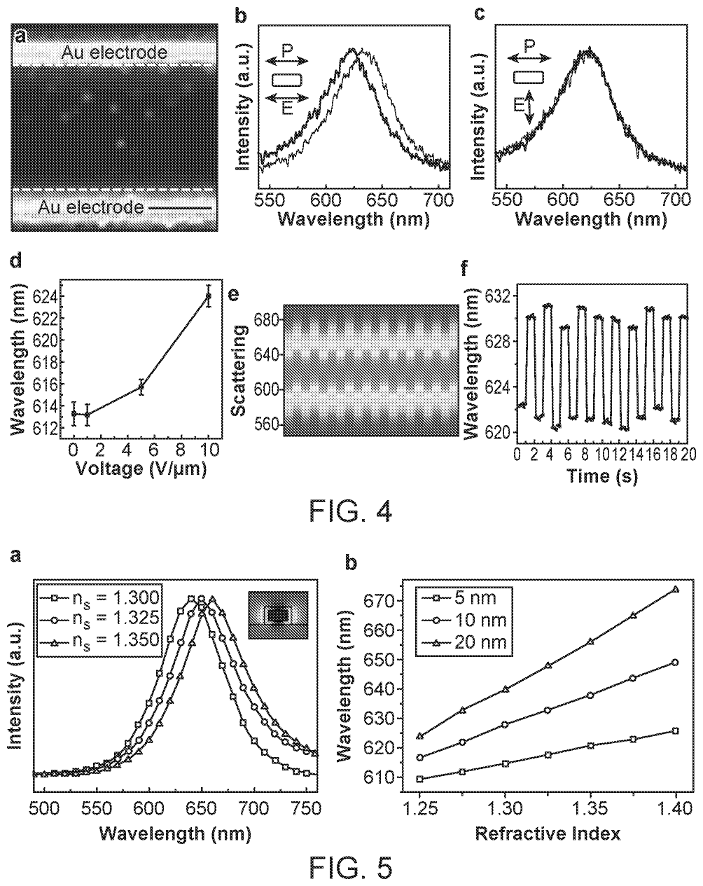

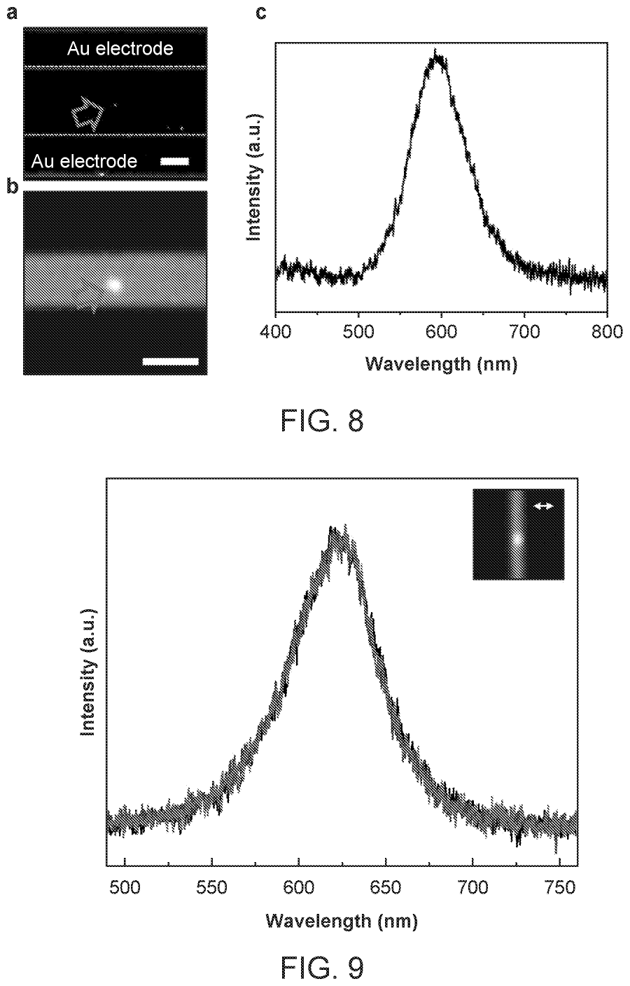

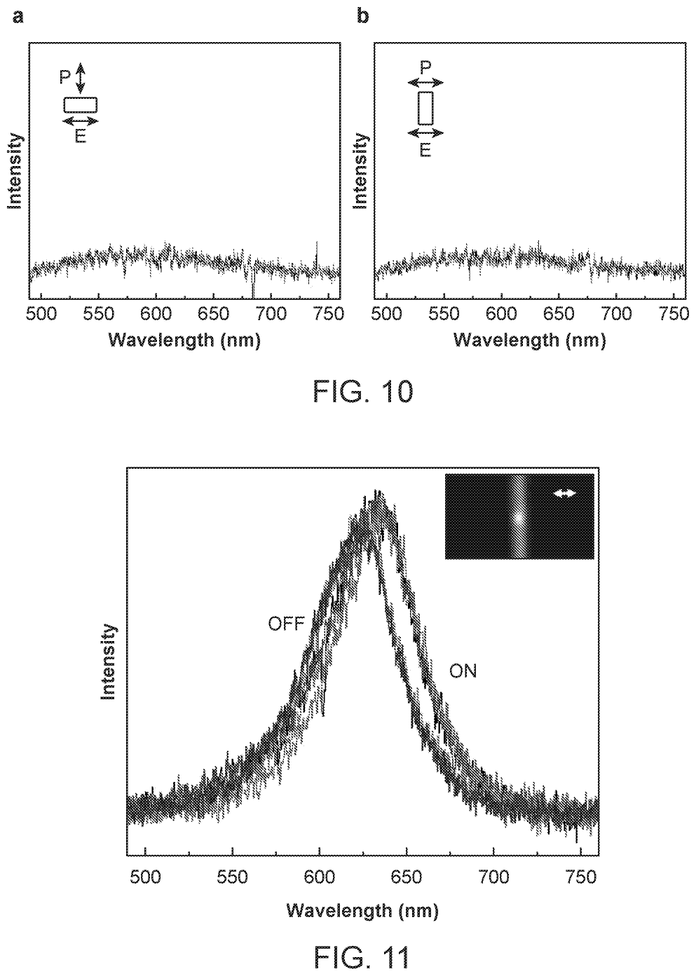

To probe the electrical field modulated plasmonic resonance properties of individual nanostructures, the Au/PANI NRs were deposited onto a glass substrate between a pair of lithographically patterned electrodes, through which a modulating electrical field can be applied (FIG. 4a, FIG. 8). The electrical field modulation of the plasmonic resonance is strongly dependent on the NR axis direction and the field direction. Polarized incident light is used to identify the NR orientation and probe the effect of the relative orientation between the NR axis and the electric field direction. For all single particle spectroscopic studies, an incident light with the polarization substantially parallel to the NR axis is used to maximize the plasmonic resonance signal. The evaluation first focused on NRs with the longitudinal axis substantially parallel to the electrical field direction to study the effect of electric fields on their LSPR characteristics. Of note, when the polarization of the incident light and the NR axis are substantially in parallel to the electrical field direction, a noticeable field-induced modulation of the plasmonic peak can be observed (FIG. 4b). The scattering spectrum for a single Au/PANI NR shows a peak at about 613.3 nm without a local electric field (the “off” state), which red-shifts to about 624.0 nm when an external electric field of about 10 V/μm was applied. As a comparison, no apparent shift can be observed when the bare Au NRs are used in the experiment (FIG. 9). This noticeable red-shift of the LSPR spectra under an external electrical field can be ascribed to the active modulation of the dielectric environment and therefore the plasmonic resonance characteristics, which is further discussed below. On the other hand, when the long axis of NR is substantially perpendicular to the field direction, no noticeable field-induced modulation can be observed (FIG. 4c). In addition, when the polarization direction of the incident light is substantially normal to the NR long axis, no contributions from the longitudinal LSPR can be collected, and the transverse LSPR scattering is too weak to be observed at the single particle level. Thus, no significant external field effect can be seen regardless of the relative orientation of the electric field vs. the NR axis (FIG. 10).

Evaluation is made of the modulation of the plasmonic response of the single Au/PANI NR by varying external fields (FIG. 4d). When the external field was relatively low (e.g., about 1 V/μm), no significant red-shift could be observed. With increasing electrical field to about 5 and about 10 V/μm, the red-shift increases to about 2.5 and about 10.7 nm, respectively. The non-linear increase of the wavelength shift is due to the polarization of the PANI shell by the external electric field, which combines the non-linear Kerr effect and the linear Pockels effect. Such electrical field modulation of plasmonic resonance is reversible and can be readily switched back and forth. Reversible switching of LSPR by the external electric field was revealed by continuously recording the LSPR spectra under a periodic modulating electrical field (about 10 V/μm) (FIG. 4e,f, FIG. 11). FIG. 4e shows 100 successive spectra of a single NR under electric field modulations. The time window for each “off/on” period is about 1 s (about 1 Hz), and 5 spectra were taken during each window with the integration time of about 200 ms for each spectrum. A significant red-shift can be observed almost instantanously (within the time resolution of the measurement) as the electric field is turned on/off, yet no noticeable difference can be seen in the 5 spectra within each window (FIG. 4e,f). These studies demonstrate that the LSPR spectra of these Au/PANI NRs can show a significant, rapid, and reversible response to the varying external electric field.

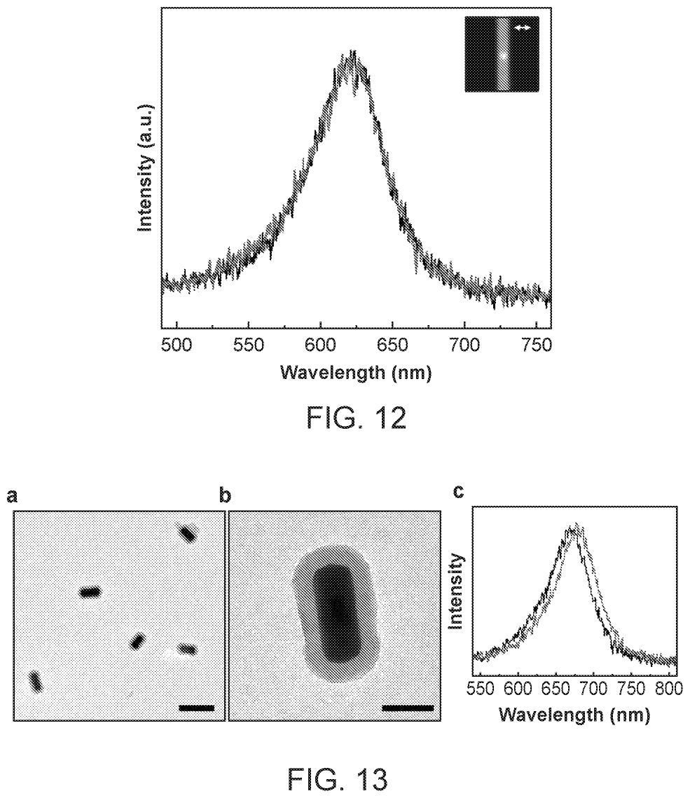

To further confirm the field-dependent behavior of the Au/PANI NRs, the finite element method (using COMSOL simulation package) is used to simulate the modulation of LSPR characteristics of Au NRs in a varying dielectric environment. An Au NR core with about 20-nm thick PANI shell is used in the simulation (FIG. 5 inset). PANI was treated as a dielectric material. By adapting the varying dielectric constant into the COMSOL simulation package, the simulation shows that a change of the refractive index by about 0.05 in the NLO shell can induce a red-shift as large as about 20 nm in the scattering spectra for a single Au/PANI core/shell NR with an aspect ratio of about 1.6 (FIG. 5a). The red-shift is also dependent on the thickness of the PANI shell (FIG. 5b). For example, Au/PANI NRs with about 5 nm of PANI shell show no significant red-shifts in their LSPR peaks (less than about 5 nm) when the refractive index of the surrounding medium increases by about 0.05, which was confirmed by experimental results (FIG. 12). These simulation results match well with experimental data and thus indicate that the Au/PANI NRs can be employed as an excellent optical voltage sensor.

The above studies demonstrate that the design of plasmonic/NLO core/shell nanostructures can exhibit an electro-optical modulation effect. To further demonstrate the generality of this concept, Au NRs are coated with other NLO materials (e.g., BTO). The Au/BTO core/shell NRs with a shell thickness of about 20 nm were prepared using a seeded hydrolysis method followed by a hydrothermal treatment. As an inorganic NLO material with local polarization structures, the dielectric constant of BTO can be modulated by an external electrical field and the difference in the refractive index can be as large as about 0.05. In the experiment, when an external electric field of about 20 V/μm was applied, a red-shift of the LSPR peak by about 9 nm is observed (from about 670 nm to about 679 nm in FIG. 13). Such field-induced spectral shift may be further improved by increasing the BTO shell thickness or improving the BTO shell crystallinity.

The electrical-field induced modulation of the LSPR in Au/PANI NRs can be attributed to the synergistic effects of both the electro-optic properties of the PANI shell and the LSPR characteristics of the Au core. As a NLO polymer, PANI can be significantly polarized by an external electric field. The electric field can change dipole orientations of the aniline unit in the polymer chain or the free aniline molecules entrapped in the PANI shell. The change of the dipole orientation and the increase of the dipole moment can then increase the dielectric constant of the PANI shell. Meanwhile, the plasmonic resonance of the embedded Au core is sensitive to the change of the dielectric constant of a surrounding environment. Together, the alteration of the dielectric constant of the outer NLO shell by an external electric field can lead to a detectable red-shift in LSPR scattering spectra. When the electric field is substantially parallel to the long axis of the Au/PANI NR, the voltage can alter the dipole orientation of the polymerized or free aniline molecules and thus cause the increase of the dielectric constant along the long axis direction, resulting in a red-shift of the LSPR spectra in the plasmonic cores.

In summary for some embodiments, through close integration of plasmonic and NLO materials into a core/shell nanostructure, a nanoscale plasmonic modulator can be formed. Polymer (PANI) or inorganic (BTO) shell can be coated onto Au NRs to realize these nano-sized sub-wavelength electro-optical modulators. Single particle scattering spectroscopy studies show that the plasmonic resonance of the Au NRs can be reversibly switched by an external electric field induced modulation of the dielectric function of the NLO shell. The electrical switching behavior shows a strong dependence on the NR orientations, the electric field direction, and the polarization direction of the incident light. The designed structures show considerable, robust spectral shift at room temperature, in contrast to the quantum-confined Stark effect in semiconductor nanoparticles that typically dictates low temperature environments or shows much smaller spectral shifts under the same electrical field. The Au/NLO NRs provide a general and robust method for the design and fabrication of sub-wavelength “electric-plasmonic-optical” modulators and nanoscale optical voltage sensors (NOVS). The approach can broadly impact areas including nanoscale electro-optics and in vitro or in vivo voltage sensors for highly parallel monitoring of cellular membrane potential in real-time. The LSPR/NLO NRs represent an optical antenna that can be modulated remotely. The described strategy can be translated to more complicated antenna architectures for optical probes monitoring variations of local electric field or for remote electric manipulation of visible light at the sub-wavelength scale. Moreover, these devices can be optimized in terms of operating voltage by selecting the plasmonic cores and other NLO materials. The chemical preparation of LSRP/NLO nanostructures with different plasmonic cores (e.g., Au, Ag, Al, and so forth) and NLO shells and their applications for monitoring cell membrane potentials are contemplated.

### Additional Embodiments

Light excitation of metallic nanostructures can cause a collective oscillation of free electrons. When an incident light frequency matches an intrinsic frequency of free electrons oscillating against a restoring force of positive nuclei in a nanostructure, a resonance is established to produce a LSPR. The LSPR in metallic nanostructures can allow for manipulation of light signal at the sub-wavelength scale, and can provide technological opportunities in a broad range of areas, including sensing, photovoltaics, catalysis, and optical antennas. The integration of plasmonic nanostructures with active dielectric materials can open a pathway towards active modulation of the plasmonic resonance by an external trigger or other stimulus (e.g., light, heat, or electric potential) and allow the development of advanced nano-devices, including active metamaterials, smart windows, and displays, as well as nanoscale sensors that can sensitively monitor local environmental changes. For example, the integration of electrical field tunable dielectric materials can allow for electrical modulation of the plasmonic optical signal and allow the creation of nanoscale sensors that sensitively transduce a local voltage signal to a detectable optical signal (optical voltage sensors).

The design of optical reporters of a voltage signal (optical voltage sensors) is of considerable interest for diverse applications, particularly for recording cell membrane potential and neural activities. Such optical reporters may omit electrical wiring and can allow for highly parallel interrogation of a large number of cells in neural circuits. However, despite the benefits, many optical voltage sensors, such as organic dyes or genetically coded fluorescence proteins, rely on indirect measurement of voltage signal and are currently constrained by relatively slow temporal response, high activation threshold or low photo-stability. Therefore, the continued development of optical voltage sensors that can sensitively and rapidly transduce electrical signal is desired for highly parallel monitoring the dynamic activities in neural circuits with high spatiotemporal resolution. Compared with organic/biological optical probes, inorganic nanostructures may provide higher quantum yields, larger Stokes shift, and improved photo-stability. For example, inorganic semiconductor quantum dots are explored as fluorescence probes for bio-imaging with extraordinary brightness, robustness against photo-bleaching and multi-color channels. Such semiconductor quantum dots or rods are considered as potential nanoscale voltage sensors because their fluorescence peak could shift under an external voltage due to the quantum-confined Stark effect. However, the voltage sensitivity of such Stark effect based fluorescence probes is typically rather small (e.g., about 2 nm spectral shift at about 10 mV/nm), which may not be sufficient for monitoring cell membrane potential.

Some embodiments are directed to the design of nanoscale optical voltage sensors (NOVS) composed of a core/shell nanostructure with a core of a plasmonic nanostructure and a shell of a non-linear optical (NLO) material (FIG. 1(c)). The integration of the NLO material surrounding the plasmonic nanostructure can allow an external electrical field to actively modulate the dielectric environment and thus the LSPR spectrum. In this way, the creation of plasmonic/NLO core/shell nanostructures provides a mechanism to sensitively transduce the local voltage (field) signal into a detectable optical signal, thus providing NOVS. Specifically, some embodiments can: (1) use finite element simulation to guide the design of a series of plasmonic/NLO core/shell nanostructures with desired plasmonic properties and electro-optical modulation; (2) develop robust chemistry to synthesize the plasmonic core with controlled composition, morphology, dimension and plasmonic resonance properties, and integrate the core with a selected NLO material shell with a controlled thickness; (3) use single particle spectroscopy to investigate the electro-optical modulation and the voltage sensitivity by the designed core/shell nanostructures; (4) use the optimized NOVS for monitoring cell membrane potential; and (5) integrate fluorescence materials with plasmonic/NLO nanostructures to convert the plasmonic signal to a fluorescence signal with reduced background noise.

### Principle of Operation.

Nanoscale integration of dissimilar materials with distinct compositions, structures and functions can create integrated nanosystems. In some embodiments, the design of NOVS is based on an intimate integration of two different materials in a hybrid core/shell nanostructure (FIG. 1c): with a core of a plasmonic material (e.g., Au, Ag, and so forth) that can exhibit strong LSPR at a given optical frequency, and a shell of a NLO material (e.g., PANI: polyaniline, BTO: barium titanate) with variable refractive index that sensitively respond to local electric fields. The LSPR frequency of the plasmonic core is sensitive to the local dielectric environment variation, and the LSPR peaks (e.g., the extinction/scattering spectra) typically red-shifts with an increasing refractive index of the local environment, and the sensitivity can be as high as about 30,000 nm/RIU (RIU: refractive index unit). Therefore, a small change in local electrical field can induce a change in the refractive index of the NLO shell, which in turn leads to a significant change in the LSPR signals that can be displayed as the red-/blue-shift in the scattering spectra. In this way, a small change in the local voltage or electrical field can be transduced into a detectable optical signal monitored by the peak shift in the scattering spectra from a single plasmonic/NLO core/shell nanostructure. The refractive index of the NLO shell can respond sensitively and rapidly (e.g., in about 10⁻¹⁴ s) to the local electric field variation, via an electro-optical nonlinear effect (Kerr effect), thus providing a fast optical readout of the local voltage signal. Together, the close integration of plasmonic and NLO materials at nanoscale creates a mechanism for highly sensitive and rapid transduction of a local voltage signal into a detectable optical signal: local voltage variation changes the refractive index of the NLO shell, which in turn modulates the LSPR spectra that can be read out with dark field optical microscope images or spectra.

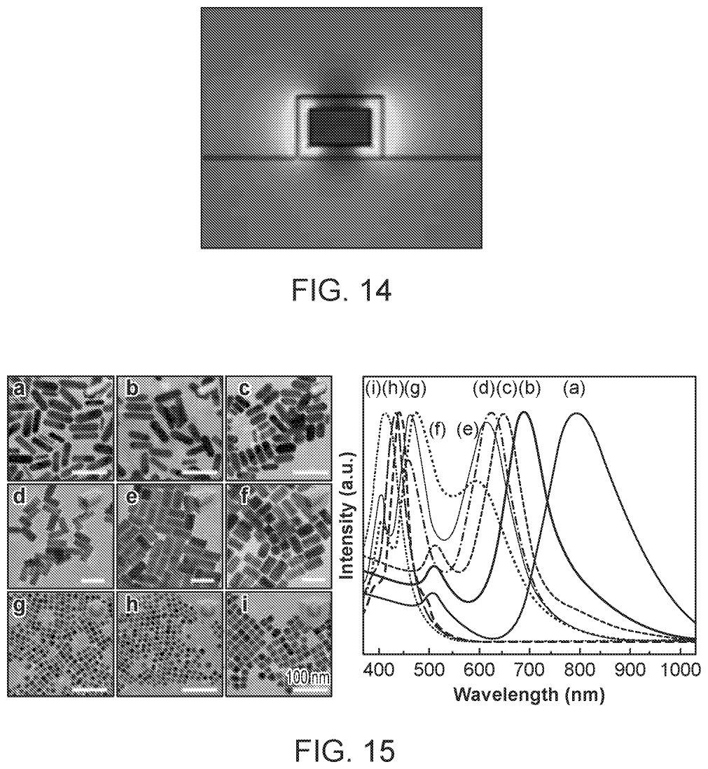

A theoretical simulation is conducted to explore the voltage induced spectral shift in the proposed NOVS, using the finite element method with a commercial simulation package (COMSOL). A NOVS with a gold nanorod (Au NR) core and a PANI shell is used as a model system in the simulation (FIG. 5 and FIG. 14). The simulation shows that a small change of the refractive index by about 0.05 in the PANI shell can induce a red-shift up to about 20 nm in Au NR LSPR spectra (FIG. 5a). Of note, such a small change of refractive index can be achieved in typical NLO materials such as PANI or BTO under a moderate field of about 1-10 mV/nm. It is also noted that the exact LSPR frequency and the amount of red-shift can also be tuned by dimensions of Au NRs and the thickness of the NLO shell, thus offering considerable flexibility to tailor the spectral response and voltage sensitivity of the proposed NOVS.

To take a step further, the voltage sensitivity of such hybrid core/shell nanostructures can be further improved by using two-dimensional (2D) materials such as graphene as a shell, which can exhibit even larger electro-optical modulation effect than other NLO materials. Theoretical simulation indicates that the dielectric constant of graphene can increase from about 3 to about 4 under a vertical field of about 10 mV/nm. Such a drastic change in dielectric constant can lead to a significant change in refractive index, and can result in an exceptional voltage sensitivity in Au/graphene core/shell nanostructures that may allow direct readout of intracellular membrane voltage, and also extracellular potential change.

### Synthesis of Plasmonic/NLO Core/Shell Nanostructures.

Noble metal nanostructures with different compositions (e.g., Au, Ag, and so forth), sizes (e.g., a few tens—a few hundreds of nm), shapes (e.g., sphere, rod, wire, core/shells, and so forth) can be used as the plasmonic core due to their strong and tunable plasmonic resonance and high sensitivity to the change of surrounding dielectric environment. A variety of noble metal nanostructures can be synthesized with well controlled sizes and morphology, and thus with controlled plasmonic resonance properties using solution phase colloid chemistry. For example, Au NRs can be prepared using a seeded growth method with cetyltrimethylammonium bromide (CTAB) as a stabilizing and structure directing agent. Of note, the size and aspect ratio of the Au NRs can be readily controlled by the ratio of seed and growth solutions. The size, morphology and aspect ratio of the resulting Au NRs can be evaluated using TEM (FIG. 15a-c). To probe the plasmonic resonance frequency, the extinction spectra of the NR solution can be recorded using a UV/visible/NIR spectrophotometer. LSPR scattering frequencies of Au NRs are readily tunable by controlling the aspect ratio (FIG. 15a-c). A similar solution chemistry strategy can be applied to synthesize other plasmonic cores with different LSPR frequencies. For example, a wide range of Au, Ag or Au/Ag core/shell nanostructures (FIG. 15a-i) can be prepared with highly tunable LSPR spectra across the entire spectrum regime from UV/blue to visible and near infrared (FIG. 15j), which can allow a great degree of flexibility in selecting proper plasmonic cores with desired LSPR spectral range for the design of NOVS. Additionally, when broader spectral regime is desired in the near infrared regime, gold nanoshells can also be synthesized to further extend the spectrum into the infrared regime.

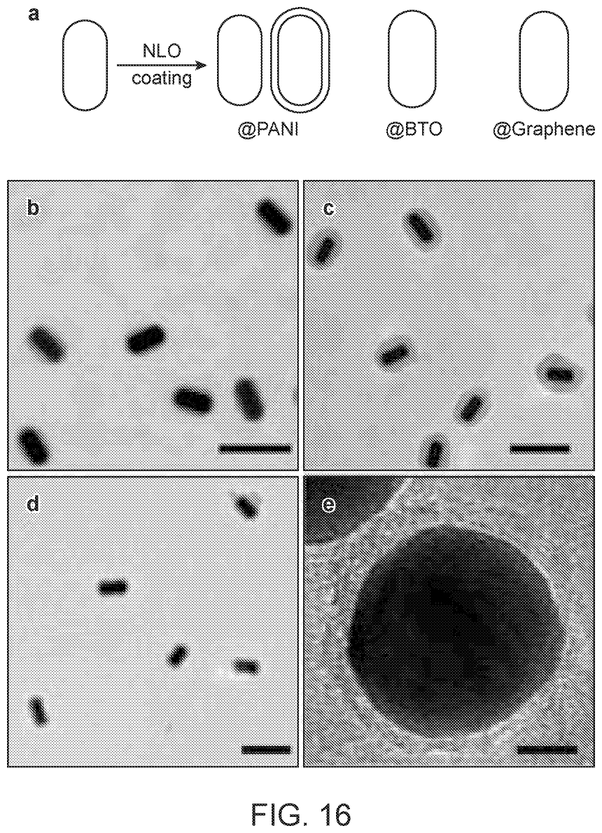

To create the designed NOVS, the metal nanostructures are then integrated with NLO materials to form Au/NLO core/shell heterostructure. Au NRs with a proper aspect ratio are used as a model system to ensure the scattering spectra are located in the visible range. Other types of plasmonic nanostructures can be explored in a similar way when desired. Different NLO materials can be used as the tunable dielectrics, including organic polymers (e.g., PANI: polyaniline), inorganic materials (e.g., BTO: barium titanate), 2D materials (e.g., graphene) and liquid crystals, among others (FIG. 16). For instance, PANI represents a semiconducting polymer with tunable conductivity, dielectric function and excellent NLO properties. BTO is a perovskite-type inorganic material with unusual ferroelectric and electro-optical properties. Proper chemistry can be used for the synthesis of Au/NLO core/shell nanostructures with controlled shell thickness.

For example, a PANI shell with controlled thickness can be coated onto Au NRs using a modified oxidative polymerization method. In brief, a mixture solution of sodium dodecylsulfate (SDS) and aniline was added into the CTAB-capped Au NR solution. A strong oxidant, (NH₄)₂S₂O₈, was then introduced to induce the polymerization of aniline on the surface of the Au NRs, producing a PANI shell on Au NRs. The resulting Au/PANI NRs can then be separated from the reaction solution through a centrifugation process. The thickness of the PANI shell can be controlled in the range of about 5-20 nm by tuning the molar ratio of aniline monomers or by repeating the coating process multiple times (FIG. 16). Different NLO shells can be coated onto these plasmonic cores using selected chemistry method, including seeded growth in solution (for inorganic materials such as BTO shell), or chemical vapor deposition (CVD) approach (for graphene shell), layer-by-layer self-assembly (for liquid crystal, polymers), and so forth. For example, inorganic BTO shells can be grown onto the surface of metal nanostructures through a seed-mediated hydrolysis followed by hydrothermal treatment. Specifically, Au NRs can be functionalized with (3-aminopropyl)triethoxysilane (APTES). Then, Ba(NO₃)₂, TiCl₃ and NaOH can be added into the solution containing Au NRs for the deposition of amorphous BTO shells onto the Au NR surface through a hydrolysis process. After that, a hydrothermal treatment may be used to form a crystallized BTO shell on the Au NRs. Graphene layers can be coated onto Au nanoparticles through a CVD method. Au nanoparticles supported by fused silica or other substrate can be placed in a tube furnace for the chemical vapor deposition of a few layers of graphene on the Au nanoparticle surfaces. Such different shells can be coated on Au nanoparticles (FIG. 16d,e), and conditions can be optimized for enhanced electro-optical modulation.

### Single-Particle Spectroscopic Studies of NOVS.

To explore the Au/NLO NRs as NOVS, it is desirable to investigate the electro-optical modulation of the LSPR properties of individual nanostructures. Single-particle dark-field scattering measurements can be conducted using an Olympus BX50 optical microscope with a dark-field objective (50×, NA=about 0.50) (FIG. 7). The microscope is integrated with a halogen lamp (100 W) for excitation, a color CCD camera for direct image, a monochromator and a liquid-nitrogen-cooled CCD camera for taking the dark-field scattering images and spectra. The scattered light (dark field image) was reflected to the entrance slit of the monochromator and projected onto the CCD camera via a mirror to obtain the dark field image. The scattering signals from a single Au/PANI NR can be selected by varying the slit width, and projected onto CCD camera via a grating in the spectrometer to obtain the scattering spectrum. Additionally, polarizers may be placed in the excitation or emission light pathway, to probe polarization dependent scattering process.

The scattering image and spectra of individual Au/PANI NRs can be readily collected and resolved with the optical setup (FIG. 3). The single-particle spectroscopy of the Au/PANI NRs reveals a plasmonic resonance peak between about 590 and about 660 nm, corresponding to the longitudinal plasmon resonance mode of the Au/PANI NRs, which may be readily timed by varying the aspect ratios of the AuNRs. The scattering peaks show a red-shift with increasing aspect ratio (FIG. 3b), consistent with the ensemble averaged UV-vis absorption. The transverse plasmonic resonance mode cannot be readily resolved in the single particle studies due to its weak scattering nature. It is also noted that the LSPR scattering spectra for a single Au/PANI NR is strongly dependent on the polarization direction of the incident light. The scattering intensity reaches its maximum when the polarization direction is substantially parallel to the NR longitudinal axis. When the polarization direction is perpendicular to the NR longitudinal axis, no noticeable scattering images or spectral peaks can be observed, further confirming the absence of the transverse LSPR in single particle scattering spectra. In this way, the long axis of a specific NR can be determined by rotating a polarizer between the incident light and the specimen. The orientation of the NR longitudinal axis corresponds to the polarization direction at which the LSPR scattering intensity reaches the maximum value.

To probe the electrical field modulated plasmonic resonance properties of individual nanostructures, the plasmonic/NLO core/shell nanostructures were deposited onto a glass substrate between a pair of lithographically patterned electrodes, through which a modulating electrical field can be applied (FIG. 1b and FIG. 4a). Electrical field modulation of the LSPR of Au/PANI NRs is strongly dependent on the NR axis direction and the field direction. It is found that, when the polarization of the incident light and the NR axis is substantially in parallel to the electrical field direction, a noticeable field-induced modulation of the plasmonic peak can be observed (FIG. 4b). The scattering spectrum for a single Au/PANI NR shows a peak at about 613.3 nm without a local electric field (the “off” state), which red-shifts to about 624.0 nm under an external electric field of about 10 V/μm. As a comparison, no significant shift can be observed when the bare AuNRs are used in the experiment. This significant red-shift of the LSPR spectra under an external electrical field can be ascribed to the active modulation of the dielectric environment and therefore the LSPR characteristics. On the other hand, when the long axis of NR is perpendicular to the field direction, no noticeable field-induced modulation can be observed (FIG. 4c).

The single particle scattering spectroscopy provides a robust approach to probe the electro-optical modulation in individual plasmonic/NLO core/shell nanostructures. This approach can be used to evaluate Au/PANI NRs and Au/BTO NRs with various aspect ratios and shell thicknesses, as well other hybrid nanostructures including Au/graphene, Au/Ag/PANI or Au/Ag/BTO core/shell/shell nanostructures in order achieve enhanced spectral modulation under a reduced field, and thus optimizing the voltage sensitivity. Furthermore, finite element simulations can be employed to guide the design, understanding and optimization of the proposed NOVS.

### Application of NOVS for Monitoring Cell Membrane Potential.

The dynamic monitoring of cell membrane potential is desired for fundamental understanding of electrophysiological signals in cellular systems and the function of neural circuits. Micropipette electrode represents the most widely adopted approach for recording cell membrane potential, which, however, suffers from low throughput and the bulk size of the electrode, and is unsuitable for highly parallel monitoring of a large number of neurons for unraveling the electrical signaling dynamics in neural circuits. Recently developed micro-or nano-electronic neuroprobes offer the potential for highly parallel recording. However, these probes are typically highly invasive and involve bulk supporting substrate and bulk external electrodes for power input and signal output, which constrain their applicability and throughput for large-scale in vitro or in vivo studies. Additionally, an 2D array of such planar devices makes it less suitable for application in three-dimensional (3D) neuron/brain tissues, and there are considerable challenges for the application of these probes for intracellular recording of neuron signals. Overall, these invasive technologies can typically monitor the biophysical signals at the single neuron level, and can be applied for parallel monitoring of a few tens or hundreds of neurons, but may be extremely difficult to implement for larger scale (e.g., a few thousands or more) recording due to the increasingly complex electrical wiring for power input and electrical signal output. Other approaches involve the use of optical reporters of voltage signal. Such optical reporters may omit electrical wiring and offer the potential for parallel interrogation of neural circuits. However, many of such optical probes (such as organic dyes or genetically coded fluorescence proteins) rely on indirect measurement of voltage signal and may suffer by relatively slow temporal response, and high activation threshold. Therefore, improved technologies and platforms are desired for the large-scale recording or manipulation of neural activity to reveal how individual cells and complex neural circuits interact in both the temporal and space dimension.

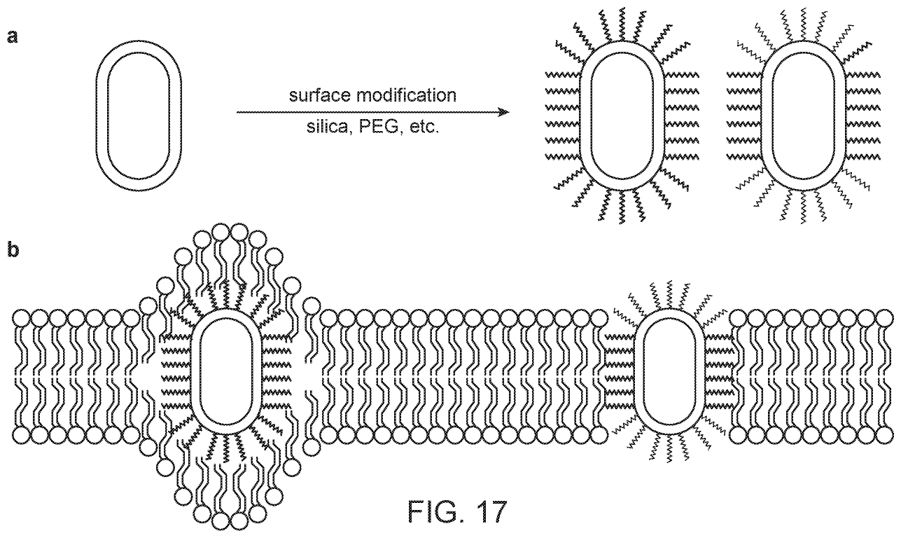

The proposed NOVS can directly transduce an electrical signal into a detectable optical signal and can exhibit sufficient voltage sensitivity (e.g., >about 10 nm shift at about 10 mV/nm) for detecting cellular membrane potential (e.g., about 100 mV/10 nm). Of note, the design of NOVS involves no electrical wiring for power input or signal output, and thus allows for direct and rapid optical readout of neuronal electrophysiological signals and mapping of brain function connectivity with unprecedented spatiotemporal resolution and throughput. The proposed NOVS represents the design of optical voltage sensors for probing cellular membrane potential and neural activities, and their voltage sensing capability can be validated in cellular or neural systems through in vitro studies. Biocompatibility can be addressed for evaluation of NOVS as neuroprobes. The surface of NOVS can be rationally tailored through well-developed chemistry to improve the biocompatibility (FIG. 17). These NOVS can be coated with a thin layer of mesoporous silica (thickness of about 1-5 nm), polyethylene glycol (PEG), or lipid layers with good biocompatibility. With the designed shell coating and surface modification (FIG. 17a), some of the delivered NOVS may be embedded in the cell membrane, and some may be positioned across the cell membrane depending on the design and surface functionalization (FIG. 17b). For example, NOVS with a hydrophobic coating may be delivered in a micelle and can be embedded within the cell membrane. Additionally, different sections of the NOVS (e.g., ends, sides, and so forth) can be functionalized with different molecules to render NOVS preferentially positioned across the cell membrane. To this end, site-selective functionalization can be achieved by kinetically controlled attachment of organic ligands or inorganic shells onto specific sites of NRs since the radius of the curvature and the stereochemistry of the surface ligands at the end of the NRs are different from that at the center portion of the NRs. By functionalizing the center portion of the NRs with hydrophobic ligands and the end portion of the NRs with hydrophilic ligands (FIG. 17a), the NRs can be preferentially positioned across the cell membrane (FIG. 17b). Additionally, specific ligands may also be engineered onto the surface of the NOVS to target selected group of neurons specific receptors. Beyond such specific targeted delivery onto cell membrane, some NOVS may be distributed in an extracellular environment, which may also be useful for probing extracellular potential variation. To monitor the dynamic neuronal activities, the dynamic signal change (the variation of scattering intensity at a given wavelength) can be monitored instead of the absolute signal intensity. In this way, both intracellular and extracellular action potential spikes may be probed concurrently by a large number of NOVS distributed within a cellular matrix.

For in vitro studies, primary mouse hippocampal neurons can be used as a model system to test the targeted delivery, biocompatibility, cell viability, sensitivity and stability of the proposed NOVS. In brief, surface functionalized NOVS can be dispersed in cell culture solutions or placed on a glass wafer, with which the primary mouse hippocampal neurons can be cultured. The location of the NOVS can be analyzed using a confocal microscope. After confirming that the NOVS can be attached to a surface or embedded in a cell membrane, a micropipette electrode can be used to probe the neuron and elicit action potential as the NOVS are being imaged under white light. The dynamic change of scattering intensity (at selected wavelength) of the NOVS can be monitored and correlated with the intracellular potential recorded by the micropipette electrodes to verify and validate the voltage sensitivity of the NOVS.

With the development and validation of the proposed NOVS in the in vitro studies, the next stage to address before in vivo applications for brain function mapping is to deliver the NOVS into brain tissue. Due to their intrinsic nanoscale and free-standing nature, the NOVS may be delivered into live brain tissues through a number of approaches: (a) solution suspended NOVS can be delivered into a local region of interest through micropipette injection. The NOVS can then float around and spread in an extra-cellular fluid to search for neurons with specific receptors to bind. (b) Ballistic delivery of nanostructures with pneumatic capillary gun is another approach for delivery of NOVS into live tissues. In this approach, the nanostructures in helium gas are accelerated to high speed to penetrate deep inside live tissues without inflicting significant damage to cells. (c) Considering the very small dimension of the NOVS, nanostructures may also be delivered into a live body through vascular systems. However for delivery through a vascular system, blood-brain barrier may impede the NOVS from entering the brain tissue. To overcome this barrier, the NOVS surface can be functionalized with a proper biocompatible coating (e.g., PEG, opioid peptide, and so forth).

### The Design of Fluorescence Based Nanoscale Optical Voltage Sensors.

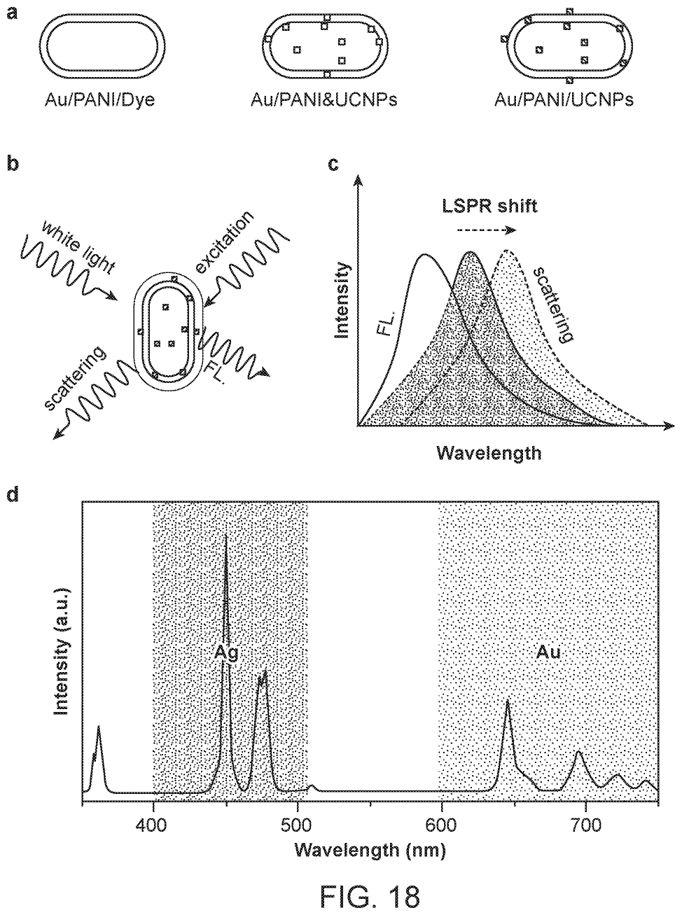

To further reduce a background noise in a scattering based plasmonic signal (image or spectrum), as another option, the scattering signal can be converted into a fluorescent (FL) signal by integrating an additional shell of a FL material. For example, plasmonic/NLO/FL nanostructures can be created by introducing an additional outer coating or shell of a FL material, embedding FL probes inside the NLO layer, or attaching FL probes on the NLO layer (FIG. 18a). Typically, LSPR can substantially modulate the FL intensity of the nearby FL material through a local field enhancement (LFE) effect or Förster resonance energy transfer (FRET) process (FIG. 18b). The variation of external electrical fields can greatly modify the LSPR spectra and thus the overlap between the LSPR and FL spectra. A closer overlap between LSPR spectra with the absorption or emission spectra of the FL material can greatly enhance FL emission intensity. In this way, a local electrical field change can modulate the coupling between the LSPR cores and the FL shells (e.g., the LFE or FRET effect), which in turn alters either emission wavelength or intensity in the FL spectra to produce a detectable FL signal (FIG. 18c). For example, when up-conversion FL materials (e.g., rare earth-doped up-conversion nanoparticles (UCNPs)) are used as the FL probes, multiple emission peaks with narrow peak width, large anti-Stokes shift, little autofluorescence, low background, and large penetration depth can be obtained with a near infrared excitation (e.g., about 800 or about 980 nm) (FIG. 18d). These multiple emission wavelengths have good overlap with different LSPR materials (see FIG. 15) and can provide multi-channel optical signals and thus highly parallel signal multiplexing. The existence of multiple emission bands in the FL material with different degree of overlap with LSPR spectra can also create an internal reference (e.g., the green/red or blue/red ratio) for determining the exact field variation.

In summary for some embodiments, by closely integrating plasmonic and NLO materials into a core/shell nanostructure, nanoscale plasmonic modulators can be designed for electro-optical modulation and nanoscale optical voltage sensing. Studies of Au/PANI core/shell NRs indicate that the plasmonic resonance of the Au NRs can be reversibly modulated by tuning the dielectric function of the NLO shell through an external electrical field. The designed structures show considerable, robust spectral shift at room temperature, in contrast to the quantum-confined Stark effect in semiconductor nanoparticles that typically involves low temperature environments or shows much smaller spectral shifts under a similar electrical field. With enhanced voltage sensitivity through selection of the plasmonic cores and NLO shells, the design of plasmonic/NLO core/shell nanostructures provides highly sensitive NOVS for in vitro or in vivo monitoring cellular membrane potential in real-time. The proposed NOVS outlines a transformative technology for electrophysiology studies. The design of NOVS provides a mechanism to directly transduce cellular voltage signals into optical signals. Considering their intrinsic nanoscale dimension (about 10-100 nm) and free-standing nature, the NOVS can be flexibly delivered into living tissues through vascular systems, micropipette injection or high speed jet injection approach, and function as minimally invasive in vivo probes. The NOVS can allow in situ monitoring of the voltage variation for a local electric field, such as for the detection of the generation and propagation of voltage signals in neuron systems. Simultaneously monitoring a large number of NOVS (e.g., in the thousands or tens of thousands) allows high throughput, high spatiotemporal resolution interrogation of neural circuits at the single neuron level and does not affect the intrinsic neuronal functions. It can thus greatly expand capability in detecting, imaging, monitoring and manipulating neuronal activities with unprecedented sensitivity, spatiotemporal resolution and throughput, and has the potential to revolutionize the future of electrophysiology. These new capabilities can greatly speed up efforts in mapping the physical and functional connectivity in neural circuits, and achieve in-depth understanding of parallel information processing in a brain. Additionally, when functionalized with proper receptor molecules, the NOVS may also function as highly sensitive sensors to monitor local pH value, ion (e.g., Ca²⁺), or other biomolecule (e.g., neurotransmitter or disease marker) fluctuations, and therefore provide a general platform for in vitro and in vivo monitoring of neuronal electrical and chemical signals. Additionally, the design of plasmonic/NLO core/shell nanostructures can also provide a pathway to the design and fabrication of high-performance nanoscale “electric-plasmonic-optical” modulators to broadly impact areas including nanoscale electro-optics. The plasmonic/NLO core/shell nanostructures represent an optical antenna that can be modulated remotely. The described strategy can be translated to more complicated antenna architectures for remote electrical manipulation of light signals at the sub-wavelength scale.

More generally, a nanostructure of some embodiments can be a heterostructure that includes a domain of a first material and a domain of a second material, where the domains are joined together or next to one another, where the first material and the second material are different, and where the domain of the second material at least partially or substantially fully covers or surrounds the domain of the first material. In some embodiments, the first material can include a plasmonic material, such as including one or more metals selected from noble metals (e.g., ruthenium (Ru), rhodium (Rh), palladium (Pd), silver (Ag), osmium (Os), iridium (Ir), platinum (Pt), gold (Au), rhenium (Re) and copper (Cu)) and other metals (e.g., aluminum (Al) or another post-transition metal or another transition metal). In some embodiments, the second material can include a non-linear optical material, such as one or more materials selected from organic polymers (e.g., PANI: polyaniline or another conductive organic polymer), inorganic materials (e.g., BTO: barium titanate; barium borate; barium germanate; cadmium zinc telluride; cesium lithium borate; gallium selenide; lithium iodate; lithium niobate; lithium tantalate; lithium triborate; monopotassium phosphate; Nd-doped YCOB (Nd:YCa₄O(BO₃)₃); potassium aluminum borate; potassium dideuterium phosphate; potassium niobate; potassium titanyl phosphate; tellurium dioxide; terbium gallium garnet; yttrium iron garnet; and zinc telluride), 2D materials (e.g., graphene) and liquid crystals, among others. In some embodiments, the domain of the first material can include two or more different metals, such as in the form of a core/shell configuration. In some embodiments, the second material is characterized as exhibiting a change in refractive index (at a working wavelength of an incident optical signal) of at least about 0.01 when exposed to an electric field of 10 V/μm, such as at least about 0.02, at least about 0.03, or at least about 0.04, and up to about 0.05 or more, or up to about 0.1 or more.

Heterostructures can have a variety of morphologies, such as core-shell, core-multi-shell, and nanoparticle-decorated core, amongst others. For example, heterostructures of some embodiments can be elongated in the form of nanorods having aspect ratios of about 2 to about 10 and lengths in the range from about 1 nm to about 100 nm, or from about 1 nm to about 50 nm, and where each nanorod includes a core of a first material and a shell of a second material covering the core of the first material. As another example, heterostructures of some embodiments can be elongated in the form of nanowires having aspect ratios greater than about 10 and up to about 50 or more, or up to about 100 or more, and lengths in the range of greater than about 100 nm and up to about 200 nm or more, or up to about 500 nm or more, and where each nanowire includes a core of a first material and a shell of a second material covering the core of the first material. As another example, heterostructures of some embodiments can be in the form of nanoparticles or nanocubes having aspect ratios in the range from about 1 to below about 2 and sizes (e.g., diameters or widths) in the range from about 1 nm to about 100 nm, or from about 1 nm to about 50 nm, and where each nanoparticle or nanocube includes a core of a first material and a shell of a second material covering the core of the first material.

Heterostructures of some embodiments can each further include a coating of a biocompatible material, and where the coating at least partially or substantially fully covers or surrounds a domain of a first material and a domain of a second material. Examples of biocompatible materials include biocompatible inorganic materials (e.g., mesoporous silica), biocompatible polymers (e.g., polyethylene glycol (PEG)), and lipids, amongst others. Heterostructures of some embodiments can be surface functionalized by organic ligands to impart properties such as hydrophilicity and hydrophobicity. For example, heterostructures can be surface functionalized by hydrophilic organic ligands (e.g., including polar chemical moieties) to render the heterostructures or selected portions thereof hydrophilic, heterostructures can be surface functionalized by hydrophobic organic ligands (e.g., including non-polar chemical moieties) to render the heterostructures or selected portions thereof hydrophobic, or heterostructures can be surface functionalized by hydrophilic organic ligands to render selected portions thereof hydrophilic and can be surface functionalized by hydrophobic organic ligands to render other portions thereof hydrophobic.

Heterostructures of some embodiments can each further include a phosphor, and where the phosphor can exhibit fluorescence. For example, a heterostructure can further include a coating of a phosphor which at least partially or substantially fully covers or surrounds a domain of a first material and a domain of a second material. As another example, a heterostructure can further include a phosphor which is embedded within either, or both, a domain of a first material and a domain of a second material. Examples of phosphors include organic phosphors (e.g., dyes) and inorganic phosphors (e.g., rare earth-doped UCNPs).

### EXAMPLE

The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

### Experimental Methods.

Chemicals. Gold(III) chloride trihydrate (HAuCl₄.3H₂O, >99.9%), silver nitrate (AgNO₃, >99%), L-ascorbic acid (>99.0%), cetyltrimethylammonium bromide (CTAB, >99.0%), aniline (>99.5%), sodium dodecyl sulfate (SDS, >99.0%), barium nitrate (>99%), titanium(III) chloride solution (TiCl₃, about 10 wt. % in about 20-30 wt. % hydrochloric acid), and hydrochloric acid (HCl, about 36.5-38.0%) were all purchased from Sigma-Aldrich. All the chemicals were used as received without further purification. The deionized (DI) water used in the experiment is ultra-pure (MilliQ, 18 MΩ).

Growth of Au NRs. Au NRs were made using a seed-mediated method in aqueous solutions. The seed solution was prepared by adding a freshly prepared ice-cold NaBH₄ solution (about 0.6 mL, about 0.01 M) into a mixture solution of HAuCl₄ (about 0.25 mL, about 0.01 M) and CTAB (about 9.75 mL, about 0.1 M) under vigorous stirring. The resultant solution was kept at about 27° C. for at least about 2 h before use. The growth solution was made by first mixing together CTAB (about 200 mL, about 0.1 M), HAuCl₄ (about 10 mL, about 0.01 M), AgNO₃ (about 2.0 mL, about 0.01 M), and a HCl solution (about 3.2 mL, about 1.0 M). A freshly prepared ascorbic acid solution (about 1.60 mL, about 0.1 M) was then added, and the resultant solution was gently shaken before the solution became colorless and transparent. Finally, the seed solution (about 10 μL) was then added and the reaction mixture was gently shaken and then left undisturbed overnight.

PANI-coated Au NRs. PANI-coated Au NRs were prepared in aqueous solutions following a method with modifications. Typically, the as-grown Au NR solution (about 3.5 mL) was centrifuged at about 7000 rpm for about 15 min and washed with DI water for one time. Then, the precipitate was collected and redispersed in a mixed solution of aniline (about 1.5 mL, about 2 mM) and SDS (about 0.25 mL, about 40 mM). The resultant solution was shaken for about 1 min, followed by the addition of an acidic (NH₄)₂S₂O₈ solution (about 1.5 mL, about 2 mM, in about 10 mM HCl). After being shaken for about 30 s, the reaction mixture was incubated at about 25° C. overnight. The PANI-coated Au NRs were separated from the reaction solution by centrifugation. The thickness of the PANI coating over the Au NRs can be controlled by the amount of aniline precursor as well as the cycles for the polymerization coating.

BTO-coated Au NRs. BTO-coated Au NRs were made by a seed-mediated hydrolysis followed by hydrothermal treatment. Firstly, the as-prepared Au NRs were washed and centrifuged twice to remove the excess CTAB and then redispersed in water. And then the surface of the Au NRs were functionalized with (3-Aminopropyl)triethoxysilane before Ba(NO₃)₂ and TiCl₃, and NaOH were added. The resultant mixture was put on a shaker at room temperature overnight to allow the growth of shell and then centrifuged and redispersed into water with poly(vinylpyrrolidone) (PVP) as a surfactant. The mixture was transferred into a Teflon-lined autoclave vessel, sealed and put into an oven at about 140° C. for another about 12 h. The products were collected and washed with water three times.

Fabrication of interdigitated electrode arrays. Interdigitated electrode arrays were fabricated over a quartz slide (or silica wafer) using photolithography. And the distance between each countering electrode can be controlled as about 5, about 10, and about 20 μm. The quality of the electrode arrays was verified by taking optical and scanning electron microscope (SEM) images as well as measuring the resistance.

Deposition of the Au/PANI NRs onto substrates. A solution of Au/PANI NRs was centrifuged at about 3000 rpm. The precipitate was collected and washed with water for one time and then dispersed in DI water. The substrate with as-prepared electrode arrays was then immersed in the solution of Au/PANI NRs for about 30 s, rinsed with water for three times, and dried with a nitrogen flow. The density of the Au/PANI NRs on substrates can be controlled by the concentration of the Au/PANI solutions as well as the time for immersing.

Single-particle dark-field scattering measurements. Single-particle dark-field scattering measurements were carried out on an Olympus BX50 optical microscope, which was integrated with a halogen lamp (100 W), a color CCD camera (Olympus DP73), an Acton SpectraPro 2300i monochromator, and a Princeton Instruments Spec10 liquid-nitrogen-cooled CCD camera (working temperature: about -110° C.). . A dark-field objective (50×, NA=about 0.50) was used during the measurements.

The scattered light was reflected to the entrance slit of the monochromator. And signals from specific Au NRs can be selected by tuning the width of the slit. The scattering spectra from the individual Au/PANI NRs were corrected by subtracting the background spectra taken from the adjacent regions without NRs and dividing with the pre-calibrated response curve of the entire optical system.

The local electric field dependent measurements were carried out with the application of a tunable DC voltage over the counter electrode to polarize the PANI coating over the Au NRs. The scattering spectra of a single Au/PANI NR were monitored and collected by the monochromator and CCD camera. A polarizer was used to ensure the orientation of the NR as well as the angles between the longitudinal axis and the applied electric field. To ensure the application of external electric field onto Au/PANI NRs, different samples were made with repeated measurements.

Other characterization. Extinction spectra were recorded on a Bruker UV/visible/NIR spectrophotometer with quartz cuvettes that had an optical path length of about 1.0 cm. TEM images were acquired on an FEI T12 microscope at about 120 kV.

Finite element simulations. The finite element method simulations were carried out with a commercial software, COMSOL. A light pulse in the wavelength range of about 450-900 nm was launched into a box containing Au/PANI NR supported on a silica substrate to simulate a propagating plane light wave interacting with the NR. The NR was surrounded by a virtual boundary with an appropriate size. The Au NR and its surrounding medium inside the boundary were divided into meshes of about 1 nm in size. The sizes of the Au NR and the thickness of the PANI shell were taken from their average values. The refractive indices of the surrounding air and the supporting silica substrate were set to be about 1.0 and about 3.9, respectively. The Au dielectric function was represented by fitting the points from the data of Johnson & Christy. PANI was treated as a dielectric material.

As used herein, the singular terms “a,” “an,” and “the” may include plural referents unless the context clearly dictates otherwise. Thus, for example, reference to an object may include multiple objects unless the context clearly dictates otherwise.

As used herein, the terms “connect,” “connected,” and “connection” refer to an operational coupling or linking. Connected objects can be directly coupled to one another or can be indirectly coupled to one another, such as via one or more other objects.

As used herein, the terms “substantially,” “substantial,” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” parallel or in parallel can refer to a range of variation of less than or equal to ±10° relative to 0°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°, and “substantially” anti-parallel can refer to a range of variation of less than or equal to ±10° relative to 180°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

As used herein, the term “nanometer range” or “nm range” refers to a range of dimensions from about 1 nm to about 1 μm. The nm range includes the “lower nm range,” which refers to a range of dimensions from about 1 nm to about 10 nm, the “middle nm range,” which refers to a range of dimensions from about 10 nm to about 100 nm, and the “upper nm range,” which refers to a range of dimensions from about 100 nm to about 1 μm.

As used herein, the term “nanostructure” refers to an object that has at least one dimension in the nm range. A nanostructure can have any of a wide variety of shapes, and can be formed of a wide variety of materials. Examples of nanostructures include nanowires, nanorods, nanotubes, nanocubes, nanosheets, and nanoparticles.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

What is claimed is:

1. A sensor comprising:
a nanostructure including a domain of a first material and a domain of a second material that covers the domain of the first material, wherein the first material is a plasmonic material, and the second material is a non-linear optical material.

2. The sensor of claim 1, wherein the domain of the first material is a core, and the domain of the second material is a shell covering the core.

3. The sensor of claim 1, wherein the first material includes a noble metal.

4. The sensor of claim 1, wherein the domain of the first material includes two different noble metals.

5. The sensor of claim 1, wherein the second material includes a conductive organic polymer.

6. The sensor of claim 1, wherein the second material is inorganic. The sensor of claim 1, wherein the second material includes graphene.

8. The sensor of claim 1, wherein the nanostructure further includes a coating of a biocompatible material, and the coating covers the domain of the second material.

9. The sensor of claim 1, wherein the nanostructure is surface functionalized by organic ligands.

10. The sensor of claim 1, wherein the nanostructure further includes a phosphor.

11. The sensor of claim 10, wherein the phosphor covers the domain of the second material, or is embedded in at least one of the domain of the first material or the domain of the second material.

12. A method of sensing, comprising:
providing a nanostructure including a domain of a first material and a domain of a second material that covers the domain of the first material, wherein the first material is a plasmonic material, and the second material is a non-linear optical material;
placing the nanostructure at a target location;
applying an input optical signal to the nanostructure at the target location; and
measuring an output optical signal induced by the nanostructure in response to an electric field at the target location.

13. The method of claim 12, wherein the input optical signal is polarized light having a polarization direction, the nanostructure is elongated along a longitudinal axis, and applying the input optical signal includes aligning the polarization direction so as to be substantially parallel to the longitudinal axis.

14. The method of claim 12, wherein the output optical signal has a peak in a visible range or an infrared range.

15. The method of claim 12, wherein the output optical signal is a plasmonic scattering signal.

16. The method of claim 15, wherein measuring the output optical signal includes measuring a shift in a peak of the plasmonic scattering signal.

17. The method of claim 12, wherein the nanostructure further includes a phosphor, and measuring the output optical signal includes measuring a fluorescence signal.
